(19) United States
(12) Patent Application Publication
(10) Pub. No.: US 2026/0318606 A1
(43) Pub. Date: Oct. 15, 2026

(54) PLATE, FIN AND HEAT EXCHANGER

(71) Applicant: DANFOSS A/S, Nordborg (DK)

(72) Inventors: Li Wang, Zhejiang (CN); Jing YANG, Zhejiang (CN); Yanxing LI, Zhejiang (CN); Jeffrey Lee TUCKER, Zhejiang (CN)

(21) Appl. No.: 19/481,934

(22) PCT Filed: Feb. 28, 2024
(86) PCT No.: PCT/CN2024/079047

§ 371 Date: Nov. 6, 2025

(30) Foreign Application Priority Data
May 10, 2023 (CN) 202310524913.2

(51) Int. Cl. F28D 1/02; B23K 1/00

(52) U.S. Cl. CPC F28D 1/0233; B23K 1/0012

(57) ABSTRACT

Disclosed in the present invention are a plate for manufacturing a welding piece, a fin made of the plate, and a heat exchanger comprising the fin. The welding piece is used for being welded together to another welding piece by means of brazing. The plate includes a zinc-containing core layer made of aluminum alloy; and two brazing filler metal layers used for brazing, the core layer being located between the two brazing filler metal layers. Using the zinc-containing core layer prolongs the service life of the heat exchanger.

### CROSS-REFERENCE TO RELATED APPLICATIONS

This application is a National Stage application of International Patent Application No. PCT/CN2024/079047, filed on Feb. 28, 2024, which claims priority to Chinese Patent Application No. 202310524913.2, filed May 10, 2023, each of which is hereby incorporated by reference in its entirety.

### TECHNICAL FIELD

The present invention relates to a plate for manufacturing a brazing member, a fin made of the plate, and a heat exchanger comprising the fin.

### BACKGROUND

A heat exchanger comprises fins, and heat exchange tubes brazed to the fins. In the course of using the heat exchanger, at least one of the heat exchange tubes and the brazed joints will corrode, causing the heat exchanger to fail; in this way, the service life of the heat exchanger is reduced.

### SUMMARY

An objective of the present invention is to provide a plate for manufacturing a brazing member, a fin made of the plate, and a heat exchanger comprising the fin, whereby, for example, the service life of the heat exchanger can be increased.

Embodiments of the present invention provide a plate for manufacturing a brazing member, the brazing member being configured to be brazed to another brazing member, the plate comprising: a zinc-containing core layer made of aluminum alloy; and two brazing material layers for brazing, the core layer being between the two brazing material layers.

According to embodiments of the present invention, the mass content of zinc in the core layer is 1%-15%.

According to embodiments of the present invention, the mass content of zinc in the core layer is 2%-10%.

According to embodiments of the present invention, the mass content of zinc in the core layer is 6%-10%.

According to embodiments of the present invention, in unit mass of the plate, the mass of zinc in the core layer is 1.5%-3.5%.

According to embodiments of the present invention, the mass content of zinc in the core layer is inversely proportional to the thickness of the core layer.

According to embodiments of the present invention, the mass content of silicon in the brazing material layer is 1%-9%.

According to embodiments of the present invention, the mass content of silicon in the brazing material layer is 2%-5%.

According to embodiments of the present invention, the mass content of silicon in the brazing material layer is 2%-4%.

According to embodiments of the present invention, the mass content of zinc in the brazing material layer is 0%-5%.

According to embodiments of the present invention, the mass content of zinc in the brazing material layer is 0%-2%.

According to embodiments of the present invention, the mass content of copper in the brazing material layer is 0%-0.5%.

According to embodiments of the present invention, the mass content of copper in the brazing material layer is 0.1%-0.3%.

According to embodiments of the present invention, the plate further comprises: a blocking layer located between the core layer and each of the two brazing material layers, the blocking layer being configured to block zinc in the core layer from diffusing to a brazed joint in the process of brazing the brazing member to the other brazing member.

According to embodiments of the present invention, the blocking layer is further configured to block silicon in the brazing material layer from migrating to the core layer in the process of brazing the brazing member to the other brazing member.

According to embodiments of the present invention, the melting point of the blocking layer is higher than the melting point of the brazing material layer.

According to embodiments of the present invention, the blocking layer is made of pure aluminum or aluminum alloy.

According to embodiments of the present invention, the thickness of the core layer is 10%-60% of the total thickness of the plate, and the total thickness of the two blocking layers is 0%-20% of the total thickness of the plate.

According to embodiments of the present invention, the plate consists of the core layer, the two blocking layers and the two brazing material layers.

According to embodiments of the present invention, the brazing member is a fin of a heat exchanger, and the other brazing member is a heat exchange tube of the heat exchanger.

Embodiments of the present invention further provide a fin for a heat exchanger, the fin being made of the plate described above.

Embodiments of the present invention further provide a heat exchanger, comprising: a heat exchange tube; and a fin made of the plate described above, the fin being brazed to the heat exchange tube by means of a brazed joint formed by melting the brazing material layer.

According to embodiments of the present invention, the heat exchange tube has a zinc-containing layer at an outermost side.

According to embodiments of the present invention, the corrosion potential of the heat exchange tube is greater than or equal to the corrosion potential of the brazed joint, and the corrosion potential of the brazed joint is greater than the corrosion potential of the fin.

According to embodiments of the present invention, the mass content of zinc in the fin is higher than at least one of the mass content of zinc in the brazed joint and the mass content of zinc in the heat exchange tube.

According to embodiments of the present invention, a blocking layer is configured to block zinc in the core layer from diffusing to the brazed joint in the process of brazing the fin to the heat exchange tube.

According to embodiments of the present invention, the fin and the heat exchange tube are configured such that, in the process of brazing the fin to the heat exchange tube, zinc in the heat exchange tube diffuses by volatilization to the fin, and zinc in the core layer of the fin diffuses toward a blocking layer.

By using the plate, fin and heat exchanger according to embodiments of the present invention, the service life of the heat exchanger can be increased, for example.

### BRIEF DESCRIPTION OF THE DRAWINGS

FIG. 1 is a schematic sectional drawing of a plate according to an embodiment of the present invention.

FIG. 2 is a schematic main view of a heat exchange tube and a fin, which have already been brazed together, of a heat exchanger according to an embodiment of the present invention, the fin being made of the plate shown in FIG. 1.

FIG. 3 is a schematic sectional drawing of a plate according to another embodiment of the present invention.

FIG. 4 is a schematic main view of a heat exchange tube and a fin, which have already been brazed together, of a heat exchanger according to another embodiment of the present invention, the fin being made of the plate shown in FIG. 3.

FIG. 5 is a schematic main view of a heat exchanger according to embodiments of the present invention.

FIG. 6 is a schematic perspective view of part of a heat exchanger according to embodiments of the present invention.

FIG. 7 is an image of the metallographic structure of a brazed joint of a heat exchange tube and a fin, and a region around the joint, wherein the brazing material layer of the plate of the fin is conventional 4343 alloy; and

FIG. 8 is an image of the metallographic structure of a brazed joint of a heat exchange tube and a fin, and a region around the joint, according to embodiments of the present invention, wherein the mass content of silicon in the alloy of the brazing material layer of the plate of the fin is about 2.5%.

### DETAILED DESCRIPTION

The present invention is explained further below in conjunction with the accompanying drawings and specific embodiments.

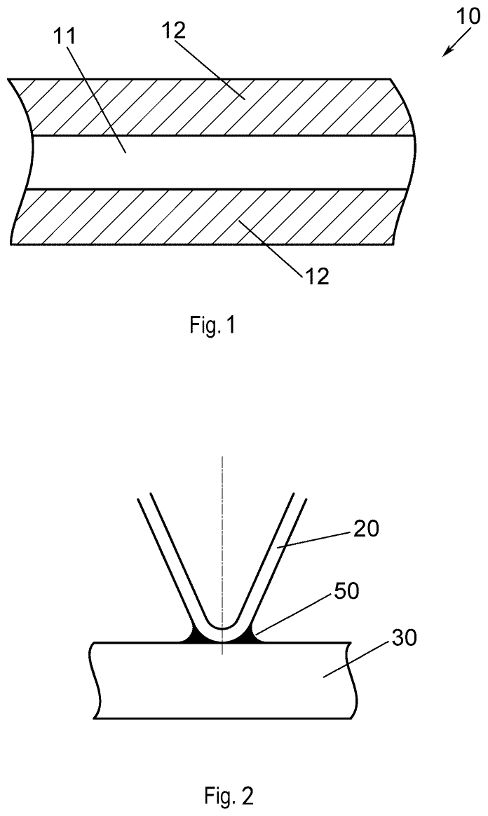

FIGS. 1-4 show a plate 10 for manufacturing a brazing member (e.g. a fin 20) according to embodiments of the present invention, the brazing member being configured to be brazed to another brazing member (e.g. a heat exchange tube 30). The plate 10 comprises: a zinc-containing core layer 11 made of aluminum alloy; and two brazing material layers 12 for brazing, the core layer 11 being between the two brazing material layers 12. The other brazing member (e.g. the heat exchange tube 30) may comprise a main body made of aluminum alloy, and a brazing material layer covering the main body. The main body may comprise a zinc-impregnated layer or a zinc-containing layer. The mass content of zinc in the core layer 11 may be 1%-15%; for example, the mass content of zinc in the core layer 11 is 2%-10%, in particular, 6%-10%. In unit mass of the plate, the mass of zinc in the core layer may be 1.5%-3.5%, e.g. 2%-3%. The mass content of zinc in the core layer 11 may be inversely proportional to the thickness of the core layer 11. The mass content of silicon in the brazing material layer 12 may be 1%-9%; for example, the mass content of silicon in the brazing material layer 12 is 2%-5%; and for example, the mass content of silicon in the brazing material layer 12 is 2%-4%. For example, the mass content of silicon in the brazing material layer 12 is less than the mass content of silicon in a typical brazing material (such as 4343). The mass content of zinc in the brazing material layer 12 may be 0%-5%; for example, the mass content of zinc in the brazing material layer 12 is 0%-2%. The mass content of copper in the brazing material layer may be 0%-0.5%; for example, the mass content of copper in the brazing material layer may be 0.1%-0.3%.

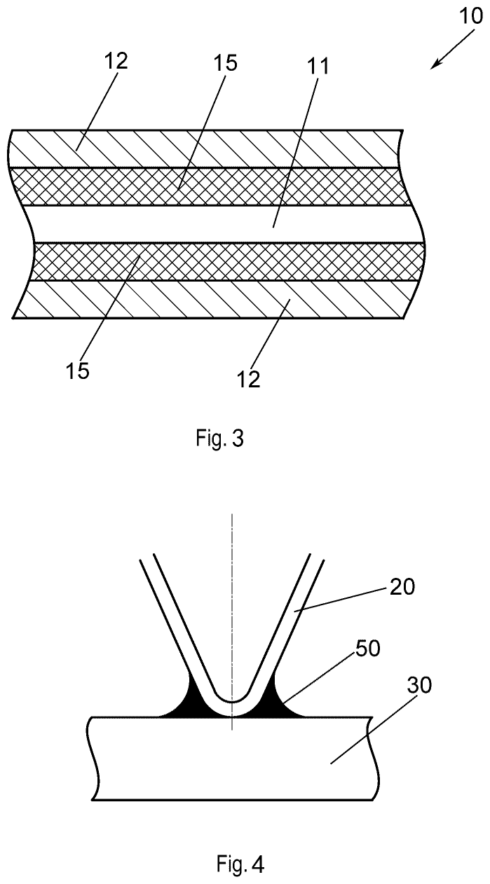

According to embodiments of the present invention, referring to FIGS. 3 and 4, the plate 10 further comprises: a blocking layer 15 located between the core layer 11 and each of the two brazing material layers 12, the blocking layer 15 being configured to block zinc in the core layer 11 from diffusing to a brazed joint 50 in the process of brazing the brazing member to the other brazing member. The blocking layer 15 may also be configured to block silicon in the brazing material layer 12 from migrating to the core layer 11 in the process of brazing the brazing member to the other brazing member. The melting point of the blocking layer 15 is higher than the melting point of the brazing material layer 12. The blocking layer 15 may be made of pure aluminum or aluminum alloy, or made of another suitable material. The thickness of the core layer 11 may be 10%-60% of the total thickness of the plate 10, and the total thickness of the two blocking layers 15 may be 0%-20% of the total thickness of the plate 10. The sum of the thickness of the core layer 11, the total thickness of the two blocking layers 15, and the total thickness of the two brazing material layers 12, is equal to the total thickness of the plate 10. For example, the plate 10 may also comprise another layer, or the plate 10 consists of the core layer 11, the two blocking layers 15 and the two brazing material layers 12.

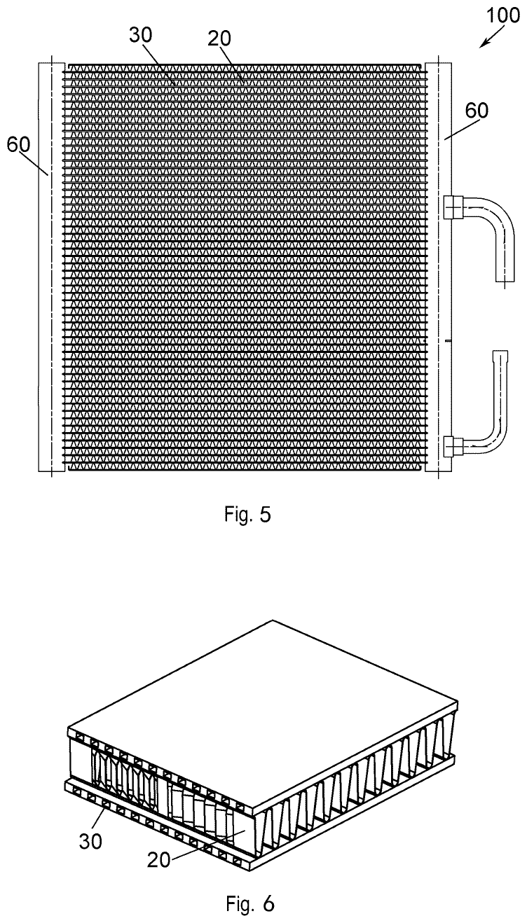

Referring to FIGS. 1-6, a heat exchanger 100 according to embodiments of the present invention comprises: heat exchange tubes 30; fins 20; and manifolds 60. The heat exchange tubes 30 are arranged alternately with the fins 20, and ends of the heat exchange tubes 30 are connected to the manifolds 60 and in fluid communication therewith. The fins 20 are components that mainly serve to enhance heat exchange. Although FIGS. 5 and 6 show wave-shaped fins, the fins of the present invention are not limited to this shape. The fins 20 of the heat exchanger may be made of the plate 10. The fins 20 are brazed to the heat exchange tubes 30 by means of the brazed joint 50 formed by melting the brazing material layer 12. The heat exchange tubes 30 may be made of aluminum alloy, and have a zinc-containing layer or a zinc-impregnated layer at an outermost side. According to embodiments of the present invention, the corrosion potential of the heat exchange tubes 30 is greater than or equal to the corrosion potential of the brazed joint 50, and the corrosion potential of the brazed joint 50 is greater than the corrosion potential of the fins 20. For example, the mass content of zinc in the fins 20 is higher than at least one of the mass content of zinc in the brazed joint 50 and the mass content of zinc in the heat exchange tubes 30. The blocking layer 15 may be configured to block zinc in the core layer 11 from diffusing to the brazed joint 50 in the process of brazing the fins 20 to the heat exchange tubes 30. The fins 20 and the heat exchange tubes 30 may be configured such that, in the process of brazing the fins 20 to the heat exchange tubes 30, zinc in the heat exchange tubes 30 diffuses by volatilization to the fins 20, and zinc in the core layer 11 of the fins 20 diffuses toward the blocking layer 15.

In the heat exchanger according to embodiments of the present invention, the core layer of the plate is a Zn-rich aluminum alloy layer, an outermost layer is a brazing material layer, and a blocking layer may be provided between the brazing material layer and the core layer. Once brazed, the fins can sacrifice themselves as anodes to provide cathodic protection for the heat exchange tubes, such as flat tubes, thereby increasing the corrosion-resistant life of the heat exchanger.

In the heat exchanger according to embodiments of the present invention, once the fins have been brazed to the heat exchange tubes, the corrosion potential of the heat exchange tubes (e.g. the zinc-containing layer or zinc-impregnated layer at the outermost side of the heat exchange tubes) is greater than or equal to the corrosion potential of the brazed joint, and the corrosion potential of the brazed joint is greater than the corrosion potential of the fins. In this way, the drawback of premature failure of the brazed joint can be avoided. Due to diffusion of the zinc of the zinc-rich core layer of the fin, the entire fin is uniformly rich in zinc, thus lowering the corrosion potential of the fin, and reduction of the mass content of silicon in the brazing material layer reduces the fluidity of the brazing material. Thus, corrosion of the heat exchange tube surface will be reduced, and at the same time, less zinc will be dissolved and the corrosion potential of the brazed joint will be increased. A suitable amount of copper added to the brazing material layer will become concentrated at the brazed joint as the brazing material layer flows and accumulates, and at the same time, the presence of copper element also increases the potential of the brazed joint, such that the corrosion potential of the brazed joint is higher than the corrosion potential of the fin. The surface area of the fin is much greater than the surface area of the heat exchange tube and the brazed joint; consequently, in a corrosive environment, a larger anode and a smaller cathode are formed, such that the fin is able to protect the brazed joint and the heat exchange tube, extending the corrosion life of the brazed joint, so the fin can have a long-lasting protective effect.

According to embodiments of the present invention, the fins can provide sacrificial anodes to protect the heat exchange tubes, and may have the three-layer structure shown in FIG. 1 or the five-layer structure shown in FIG. 3. The core layer may be a Zn-rich aluminum alloy layer, the outermost layer may be a brazing material layer, and a blocking layer may be provided between the brazing material layer and the core layer. The brazing material layers and the blocking layers respectively form a symmetric structure centered at the core layer. The melting points of the core layer and the blocking layer are higher than the melting point of the brazing material layer at the outermost layer. The blocking layer blocks zinc in the core layer, preventing zinc in the core layer from prematurely diffusing to the brazing material layer, and at the same time blocks silicon in the brazing material layer from migrating to the core layer; the blocking layer may be a pure aluminum or aluminum alloy layer.

According to embodiments of the present invention, the corrosion life of the brazed joint of the fin and the heat exchange tube is increased; in this way, a fin-protecting effect is achieved, and the service life of the heat exchanger is increased. According to embodiments of the present invention, in the following examples, once the fins have been brazed to the heat exchange tubes, the corrosion potential of the heat exchange tubes (e.g. the zinc-containing layer or zinc-impregnated layer at the outermost side of the heat exchange tubes) is greater than or equal to the corrosion potential of the brazed joint, and the corrosion potential of the brazed joint is greater than the corrosion potential of the fins. Since the diffusion of zinc in the core layer requires time in the process of brazing, the zinc in the brazed joint formed by the fin and the heat exchange tube mainly comes from the brazing material layer and the heat exchange tube (e.g. the surface of the heat exchange tube), such that the mass content of zinc in the brazed joint is lower than the mass content of zinc in the fin, thereby increasing the corrosion potential of the brazed joint, so that the fin can protect the heat exchange tube and at the same time also protect the brazed joint. In addition, reduction of the mass content of silicon in the brazed material layer helps to increase corrosion resistance at the brazing position, because the reduction of the mass content of silicon increases the liquidus temperature of the brazing material. For a fixed brazing temperature, compared with a brazing material layer with a higher mass content of silicon, the brazed joint formed is in a liquid state for a shorter time, fluidity is reduced, the heat exchange tube suffers less corrosion, there is less dissolved zinc, and the brazed joint formed during cooling is smaller. As a result, less copper diffuses into the heat exchange tube, and there is more primary aluminum in the metallographic structure formed at the brazing position. This helps to increase the corrosion potential of the joint, increasing the corrosion-resistant life of the joint. At the same time as the fin and the heat exchange tube form the brazed joint, zinc at the surface of the heat exchange tube diffuses to the surface of the fin via zinc vapor, then diffuses into the fin via the surface of the fin, and at the same time, Zn in the core layer diffuses outward, such that the entire fin is rich in zinc. These two aspects of zinc diffusion are added together, increasing the zinc content of the fin, and this is more conducive to a reduction in the corrosion potential of the fin to below the corrosion potentials of the heat exchange tube surface and the brazed joint. Moreover, as time passes during brazing, the zinc content at all parts of the fin tends to become uniform, so that the fin has a cathodic protection effect. Since the surface area of the fin is much greater than the surface area of the heat exchange tube and the brazing joint, a larger anode and a smaller cathode are formed, such that the fin has the effect of cathodic protection, thereby increasing the corrosion-resistant life of the heat exchanger.

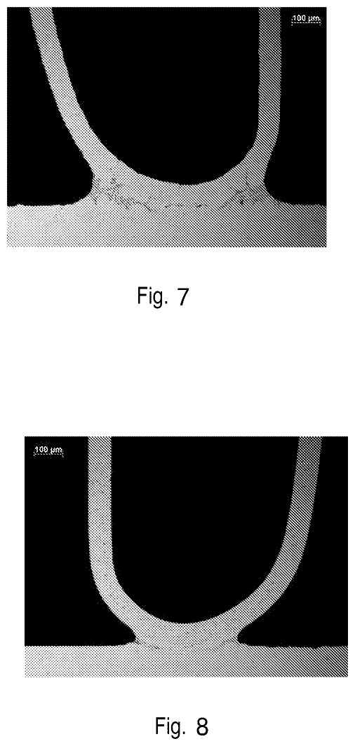

Table 1 below shows the lengths of brazed joints of heat exchange tubes and fins manufactured using conventional plate, and the lengths of brazed joints of heat exchange tubes and fins manufactured using the plate according to embodiments of the present invention. The brazing material layer of the plate according to embodiments of the present invention used in testing has a reduced mass content of silicon. Specifically, Table 2 shows the mass contents of elements in the materials of the brazing material layer and core layer of the plate of the fin according to embodiments of the present invention used in testing. A brazing material layer of conventional plate is 4343 alloy. The upper brazed joint in Table 1 is a brazed joint of the fin and the heat exchange tube at an upper side of the heat exchange tube, the lower brazed joint in Table 1 is a brazed joint of the fin and the heat exchange tube at a lower side of the heat exchange tube, and the length of the brazed joint is the length of the brazed joint 50 shown in FIGS. 2 and 4 in the longitudinal direction of the heat exchange tube 30 (the left-right direction in the figures), i.e. the length of extension of the brazed joint 50 from one side of the bottom of the trough of the heat exchange tube 30 to the other side. It can be seen from Table 1 that when the plate according to embodiments of the present invention is used, the liquidus temperature of the brazing material is increased because the mass content of silicon in the brazing material layer is reduced; for a fixed brazing temperature, compared with a brazing material layer with a higher content of silicon, the brazed joint formed is in a liquid state for a shorter time, the heat exchange tube suffers less corrosion, there is less dissolved zinc, and the brazed joint formed when the formed joint cools is smaller. FIGS. 7 and 8 are images of the metallographic structure of the brazed joints in Table 1, and regions around the joints. Specifically, FIG. 7 is an image of the metallographic structure of a brazed joint of a heat exchange tube and a fin manufactured using conventional plate, and a region around the joint, and FIG. 8 is an image of the metallographic structure of a brazed joint of a heat exchange tube and a fin manufactured using the plate according to embodiments of the present invention, and a region around the joint. As can be seen from FIGS. 7 and 8, when the plate according to embodiments of the present invention is used, the melting point of the brazing material is increased because the mass content of silicon in the brazing material layer is reduced; for a fixed brazing temperature, compared with a brazing material layer with a higher content of silicon, the brazed joint formed is in a liquid state for a shorter time, the heat exchange tube suffers less corrosion, and there is less dissolved zinc. As a result, less copper diffuses into the heat exchange tube, and there is more primary aluminum in the metallographic structure formed at the brazing position. This helps to increase the corrosion potential of the brazed joint, increasing the corrosion-resistant life of the brazed joint.

TABLE 1
(results of multiple tests)

| | | | | | | | | | | | Mean |
|---|---|---|---|---|---|---|---|---|---|---|---|
| Length of brazed joint | | | | | | | | | | | value |
| Ordinary plate, | Upper | 656 | 648 | 629 | 446 | 536 | 616 | 558 | 570 | 599 | 593 |
| with 4343 alloy | brazed | | | | | | | | | | |
| as brazing | joint/μm | | | | | | | | | | |
| material layer | Lower | 648 | 649 | 648 | 600 | 601 | 580 | 560 | 579 | 549 | |
| | brazed | | | | | | | | | | |
| | joint/μm | | | | | | | | | | |
| Material shown | Upper | 406 | 424 | 410 | 363 | 365 | 356 | 345 | 364 | 353 | 372 |
| in Table 2 | brazed | | | | | | | | | | |
| according to | joint/μm | | | | | | | | | | |
| embodiments of | Lower | 416 | 404 | 404 | 349 | 366 | 353 | 354 | 353 | 312 | |
| the present | brazed | | | | | | | | | | |
| invention | joint/μm | | | | | | | | | | |

TABLE 2

| | Element | Si | Fe | Cu | Mn | Mg | Cr | Zn | Bi | Zr | Ti | Ni | Al |
|---|---|---|---|---|---|---|---|---|---|---|---|---|---|
| Brazing layer | Maximum | 3.5 | 0.3 | 0.02 | 0.1 | 0.01 | 0.01 | 0.1 | 0.05 | 0.01 | 0.01 | 0.01 | Remainder |
| (mass content | Minimum | 2.6 | 0 | 0 | 0 | 0 | 0 | 0 | 0 | 0 | 0 | 0 | |
| percentages) | | | | | | | | | | | | | |
| Core layer | Maximum | 0.6 | 0.7 | 0.2 | 1.5 | 0.05 | — | 0.1 | — | — | — | — | Remainder |
| (mass content | Minimum | 0 | 0 | 0.05 | 1 | 0 | | 0 | | | | | |
| percentages) | | | | | | | | | | | | | |

According to embodiments of the present invention, the reduction in the mass content of silicon in the fin reduces the fluidity of the brazing material, such that the brazing material dissolves less material at the surface of the heat exchange tube (zinc-rich layer), and the brazed joint formed is smaller. Less dissolution of zinc by the brazing material helps to increase the corrosion potential of the brazed joint. At the same time, the eutectic phase of the brazed joint formed is smaller, and there is more primary aluminum. This also helps to increase the corrosion potential of the brazed joint, thereby increasing the corrosion resistance of the joint, enabling the fin to have a longer-lasting protective effect, and increasing the service life of the heat exchanger. In addition, the reduction in the mass content of silicon can reduce the effect which the brazing material of the fin has on the surface of the heat exchange tube, and can effectively avoid the problem of uneven distribution and local concentration of zinc caused by flow and accumulation of the brazing material of the fin, reducing the risk of pitting of the heat exchange tube; at the same time, the reduction in the mass content of silicon also reduces the risk of copper diffusing into the heat exchange tube. Furthermore, diffusion of the Zn of the core layer and volatilization/penetration of zinc at the surface of the heat exchange tube causes the mass content of zinc in the fin to be higher than the mass content of zinc in the heat exchange tube and the brazed joint, reducing the corrosion potential of the fin, producing a cathodic protection effect, and enabling the fin to protect the heat exchange tube and the brazed joint. The reduction of the mass content of silicon in the brazing material layer is a precondition for the added copper and zinc functioning; if the mass content of silicon in the brazing material layer is not reduced, the action or advantages of the zinc and copper will be greatly reduced, and the zinc and copper may even act in the opposite way. If the mass content of silicon in the brazing material layer is reduced, and zinc and copper are added to the brazing material layer, the optimal protective effect of the fin can be produced, with the effect of extending the service life of the heat exchanger.

Although the above embodiments have been described, some features in the above embodiments may be combined to form new embodiments.

While the present disclosure has been illustrated and described with respect to a particular embodiment thereof, it should be appreciated by those of ordinary skill in the art that various modifications to this disclosure may be made without departing from the spirit and scope of the present disclosure.

What is claimed is:

1. A plate for manufacturing a brazing member, the brazing member being configured to be brazed to another brazing member, the plate comprising:
a zinc-containing core layer made of aluminum alloy; and
two brazing material layers for brazing, the core layer being between the two brazing material layers, wherein:
the mass content of silicon in the brazing material layer is 2%-5%.

2. The plate as claimed in claim 1, wherein:
the mass content of zinc in the core layer is 1%-15%.

3. The plate as claimed in claim 2, wherein:
the mass content of zinc in the core layer is 2%-10%.

4. (canceled)

5. The plate as claimed in claim 1, wherein:
in unit mass of the plate, the mass of zinc in the core layer is 1.5%-3.5%.

6. The plate as claimed in claim 1, wherein:
the mass content of zinc in the core layer is inversely proportional to the thickness of the core layer.

7. (canceled)

8. (canceled)

9. The plate as claimed in claim 7, wherein:
the mass content of silicon in the brazing material layer is 2%-4%.

10. The plate as claimed in claim 1, wherein:
the mass content of zinc in the brazing material layer is 0%-5%.

11. The plate as claimed in claim 10, wherein:
the mass content of zinc in the brazing material layer is 0%-2%.

12. The plate as claimed in claim 1, wherein:
the mass content of copper in the brazing material layer is 0%-0.5%.

13. (canceled)

14. The plate as claimed in claim 1, further comprising:
a blocking layer located between the core layer and each of the two brazing material layers, the blocking layer being configured to block zinc in the core layer from diffusing to a brazed joint in the process of brazing the brazing member to the other brazing member.

15. The plate as claimed in claim 14, wherein:
the blocking layer is further configured to block silicon in the brazing material layer from migrating to the core layer in the process of brazing the brazing member to the other brazing member.

16. The plate as claimed in claim 14, wherein:
the melting point of the blocking layer is higher than the melting point of the brazing material layer.

17. The plate as claimed in claim 14, wherein:
the blocking layer is made of pure aluminum or aluminum alloy.

18. (canceled)

19. The plate as claimed in claim 14, wherein:
the plate consists of the core layer, the two blocking layers and the two brazing material layers.

20. The plate as claimed in claim 1, wherein:
the brazing member is a fin of a heat exchanger, and the other brazing member is a heat exchange tube of the heat exchanger.

21. A fin for a heat exchanger, the fin being made of the plate as claimed in claim 1.

22. A heat exchanger, comprising:
a heat exchange tube; and
a fin made of the plate as claimed in claim 1, the fin being brazed to the heat exchange tube by means of a brazed joint formed by melting the brazing material layer.

23. (canceled)

24. The heat exchanger as claimed in claim 22, wherein:
the corrosion potential of the heat exchange tube is greater than or equal to the corrosion potential of the brazed joint, and the corrosion potential of the brazed joint is greater than the corrosion potential of the fin.

25. The heat exchanger as claimed in claim 22, wherein:
the mass content of zinc in the fin is higher than at least one of the mass content of zinc in the brazed joint and the mass content of zinc in the heat exchange tube.

26. The heat exchanger as claimed in claim 22, wherein:
a blocking layer is configured to block zinc in the core layer from diffusing to the brazed joint in the process of brazing the fin to the heat exchange tube.

27. (canceled)
